(19) United States
(12) Patent Application Publication
(10) Pub. No.: US 2006/0046597 A1
(43) Pub. Date: Mar. 2, 2006

(54) Permeable artificial leather with realistic feeling and method for making the same

(75) Inventors: Ko-Feng Wang, Fengshan City (TW); I-Peng Yao, Kaohsiung City (TW); Mao-Kan Lee, Liujiao Shiang (TW); Chen-Hsiang Chao, Kaohsiung City (TW); Zhing-Hwng Chen, Kaohsiung City (TW); Ming-Cheng Chang, Kaohsiung City (TW); Yung-Chang Hung, Kaohsiung City (TW)

Correspondence Address: NIKOLAI & MERSEREAU, P.A., 900 SECOND AVENUE SOUTH, SUITE 820, MINNEAPOLIS, MN, 55402, US

(73) Assignee: SAN FANG CHEMICAL INDUSTRY CO., LTD., Jenwu Shiang (TW)

(21) Appl. No.: 11/199,437

(22) Filed: Aug. 8, 2005

(30) Foreign Application Priority Data
Aug. 24, 2004 (TW) 093125412

(51) Int. Cl. D04H 13/00; B32B 27/12

(52) U.S. Cl. 442/394; 442/327; 442/361; 442/363

(57) ABSTRACT

A method is disclosed for making permeable artificial leather that is realistic and permeable regarding air and liquid. At first, a non-woven cloth provided. A semi-product of the artificial leather is provided by means of immersing the non-woven cloth in a solution of a polymer resin. A highly porous sheet is provided. Finally, the final product of the artificial leather is provided by means of adhering the highly porous sheet to the semi-product of the artificial leather so that gaps exist between the highly porous sheet and the semi-product of the artificial leather.

### BACKGROUND OF INVENTION

1. Field of Invention

The present invention relates to a method for making permeable artificial leather.

2. Related Prior Art

Referring to FIG. 1, there is shown a conventional method for making realistic artificial leather. The conventional method includes a dry process 100 and a wet process 101. The dry process 100 includes two steps 102 and 104. At step 102, a piece of releasing paper is coated with a dry polyurethane resin in order to form a dry polyurethane resin layer with a thickness of 0.01 mm to 0.05 mm. At step 104, the dry polyurethane resin layer is coated with an adhesive polyurethane resin in order to form an adhesive layer with a thickness of 0.01 mm to 0.05 mm.

The wet process 101 includes four steps 106 through 114. At step 106, a substrate is immersed in a polyurethane resin in order to fill the polyurethane resin in the substrate. At step 108, the substrate is coated with a coating polyurethane resin. At step 110, the coating is cured. At step 112, the coating is washed in order to form a foam layer on the substrate. At step 114, the adhesive layer made in the dry process is adhered to the foam layer made in the wet process. At step 116, the piece of releasing paper is removed in order to provide the realistic artificial leather.

The realistic artificial leather is poor in permeability regarding air and water and cannot fulfill customers' demands for comfort.

In U.S. Pat. No. 6,451,716, “Leather-like sheet and process for the production thereof”, there is discloses a method for making a permeable leather-like sheet. There is provided a non-woven cloth made of nylon or polyester fibers under 0.2 denier. The non-woven cloth is immersed in a solution of a first polymer. The non-woven cloth is coated with a second polymer. The second polymer is cured. Dimethylformamide (“DMF”) is removed from the second polymer. The second polymer is dried. A solvent is provided on the second polymer by means of a 250-eye photogravure roll in order to partially dissolve and make holes in the surface thereof. Then, the sheet is subject to a solvent in order to make the fibers fine. The sheet is heated and pressed before or after a surface layer is formed. However, the fibers cannot easily be made fine because the laminate is coated with a foam layer. Moreover, the resultant artificial leather fails to exhibit the grain effects of real leather. Furthermore, the resultant artificial leather is poorly permeable.

The present invention is therefore intended to obviate or at least alleviate the problems encountered in prior art.

### SUMMARY OF INVENTION

According to the present invention, a method is provided for making permeable artificial leather that is realistic and permeable regarding air and liquid. At first, a non-woven cloth is provided. A semi-product of the artificial leather is provided by means of immersing the non-woven cloth in a solution of a polymer resin. A highly porous sheet is provided. Finally, the final product of the artificial leather is provided by means of adhering the highly porous sheet to the semi-product of the artificial leather so that gaps exist between the highly porous sheet and the semi-product of the artificial leather.

Other advantages and novel features of the invention will become more apparent from the following detailed description in conjunction with the drawings.

### BRIEF DESCRIPTION OF DRAWINGS

The present invention will be described through the description of embodiments referring to the drawings.

FIG. 1 is a block diagram of a conventional method for making artificial leather.

FIG. 2 is a block diagram of a method for making artificial leather according to the present invention.

FIG. 3 shows a method for making a semi-product of the artificial leather according to a second embodiment of the present invention

FIG. 4 is a sectional view of a non-woven cloth.

FIG. 5 is a view similar to FIG. 4, wherein the non-woven cloth is immersed in a solution of a polymer resin.

FIG. 6 is a view similar to FIG. 5, wherein the non-woven cloth coated with the polymer is dried to obtain a semi-product of the permeable artificial leather.

FIG. 7 is a view similar to FIG. 6, wherein a highly porous sheet is adhered to the semi-product of the permeable artificial leather.

FIG. 8 is a view similar to FIG. 6, wherein a superficial layer is formed on the highly porous sheet.

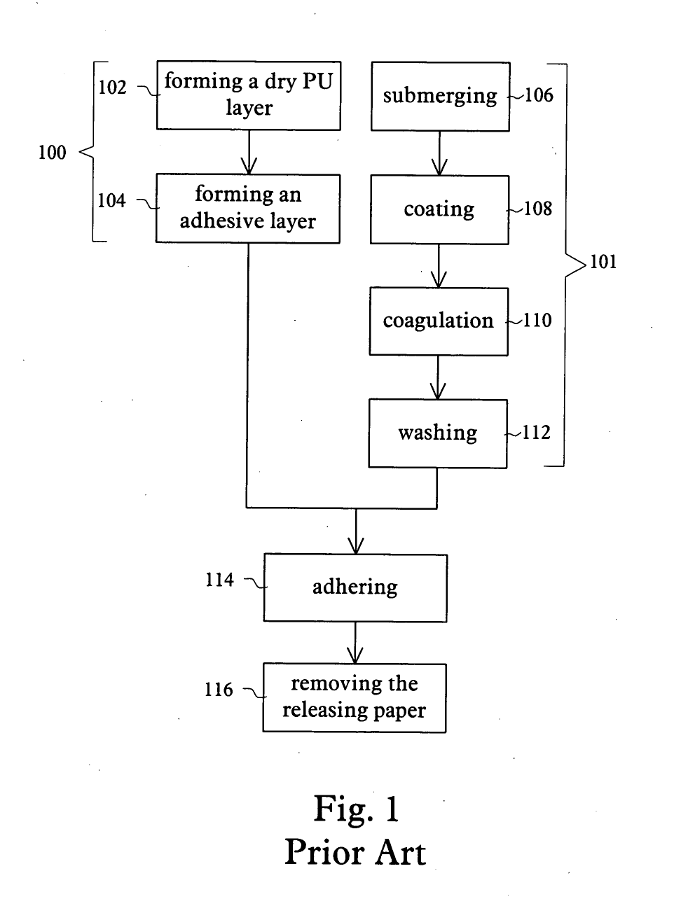

### DETAILED DESCRIPTION OF EMBODIMENTS

### First Embodiment

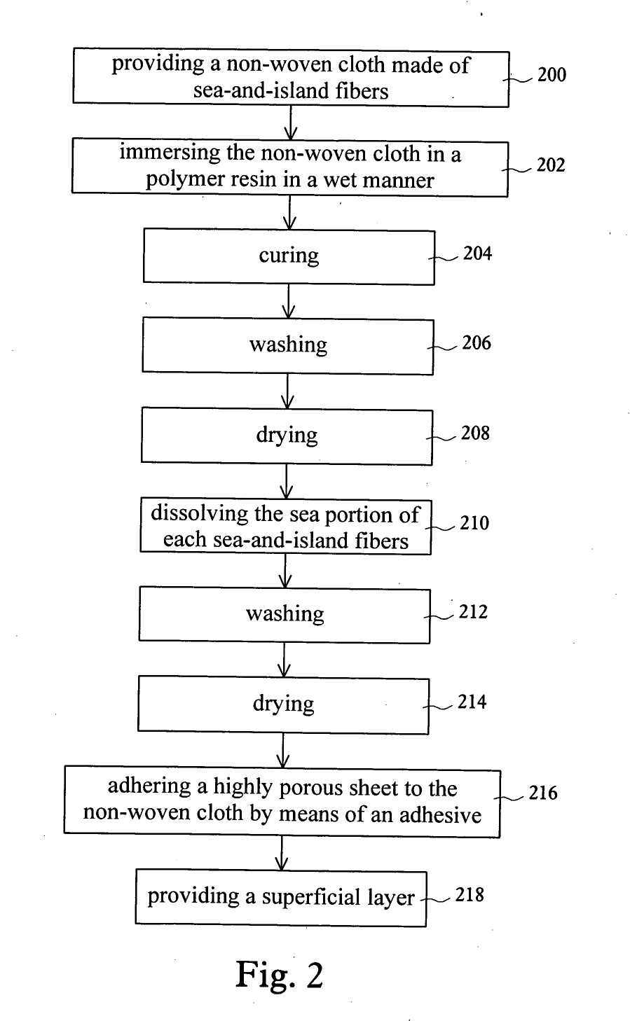

Referring to FIG. 2, there is shown a method for making permeable artificial leather according to a first embodiment of the present invention.

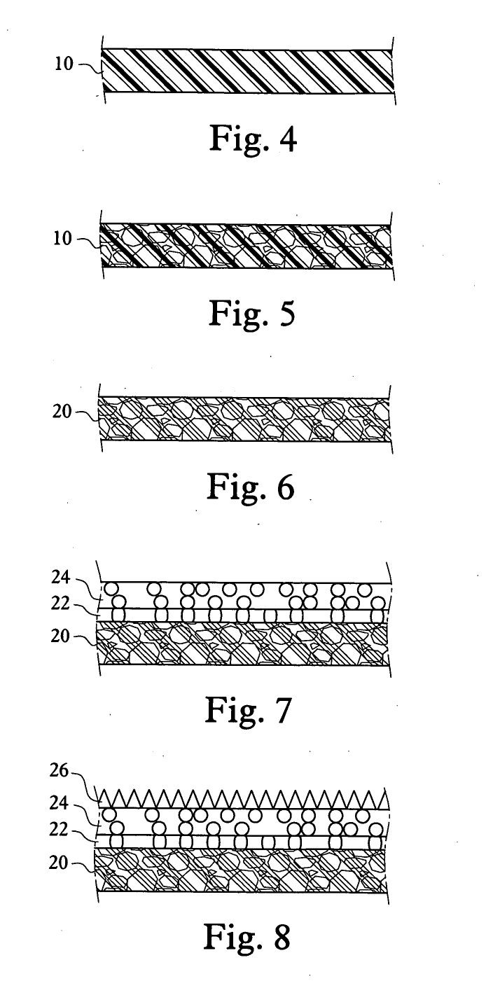

At step 200, a non-woven cloth 10 (FIG. 4) is made of sea-and-island type fibers by means of needle punching. The sea-and-island type fibers are 1 to 10 denier and, more preferably, 2 to 6 denier. Each sea-and-island fiber includes a sea portion and at least one island portion enclosed in the sea portion. The sea portion may be selected from a group consisting of nylon, polyester and polyolefin while the island portion one of the remaining others in the group. Alternatively, the sea portion may be made of polyester, and the island portion nylon.

At step 202, the non-woven cloth 10 is immersed in a solution of a polymer resin (FIG. 5).

At step 204, the polymer is cured.

At step 206, the non-woven cloth 10 coated with the polymer resin is washed.

At step 208, the non-woven cloth 10 coated with the polymer resin is dried.

At step 210, the sea portion of each fiber is dissolved in a solvent and removed. Each fiber becomes 0.0001 to 0.8 denier after the removal of the sea portion.

At step 212, the non-woven cloth 10 coated with the polymer is washed.

At step 214, the non-woven cloth 10 coated with the polymer is dried. Thus, a semi-product 20 (FIG. 6) of the permeable artificial leather is made.

At step 216, a highly porous sheet 24 is adhered to the semi-product 20 of the permeable artificial leather by means of an adhesive 22 (FIG. 7).

The highly porous sheet 24 may be made of polyurethane. The highly porous sheet 24 of course includes a plurality of holes defined therein. The porosity ratio of the highly porous sheet 24 is preferably 60% to 90%. The density of the highly porous sheet 24 is preferably 0.10 to 0.45 g/cm³.

The adhesive 22 is provided between the highly porous sheet 24 and the semi-product 20 in a discontinuous manner, i.e., the adhesive 22 does not form a continuous layer. The adhesive 22 may be provided in dots or a net-like manner with an eyed photogravure roll or by means of screen-printing. Thus, some points of the highly porous sheet 24 are not adhered to some points of the semi-product 20. Hence, there are gaps between the highly porous sheet 24 and the semi-product 20. The gaps between the highly porous sheet 24 and the semi-product 20 are in communication with the holes of the highly porous sheet 24. Air and liquid can enter and leave the gaps through the holes. Hence, the final product of the artificial leather will be highly permeable.

At step 218, by means of a piece of releasing paper, a superficial layer 26 (FIG. 8) is formed on the highly porous sheet 24. The superficial layer 26 may be subject to a milling process so that it becomes a permeable grain layer. Thus, the superficial layer 26 is made with a realistic texture that is open to the highly porous sheet 24. The artificial leather is thus permeable to air and liquid throughout its thickness.

Two examples will be given in order to further discuss the method for making the permeable artificial leather according to the first embodiment of the present invention.

### EXAMPLE 1

At step 200, the non-woven cloth 10 is made of sea-and-island type fibers by means of needle punching. Each sea-and-island type fiber includes a sea portion of polyester and an island portion of nylon. The thickness of the non-woven cloth 10 is 1.5 mm. The density of the non-woven cloth 10 is 380 g/m².

At step 202, the solution contains 7% of the polymer resin, 1% of dye, and 92% of DMF solvent. The non-woven cloth 10 is immersed in the solution.

At step 204, the polymer resin is cured.

At step 206, the non-woven cloth 10 coated with the polymer resin is washed.

At step 208, the non-woven cloth 10 coated with the polymer resin is dried.

At step 210, the solvent contains 5% of alkali. The non-woven cloth 10 coated with the polymer resin is immersed in the solvent in order to dissolve and remove the sea portion of polyester of each sea-and-island type fiber.

At step 212, the artificial leather is washed.

At step 214, the artificial leather is dried. Now, the fibers become 0.07 denier, and the semi-product 20 of the permeable artificial leather is made. The semi-product 20 of the permeable artificial leather is grinded in order to reduce the thickness thereof to 0.8 mm. At step 216, the highly porous sheet 24 is made of polyurethane, and the porosity ratio is 80%, and the thickness 0.3 mm. The adhesive 22 is made of polyurethane. The highly porous sheet 24 is adhered to the semi-product 20 of the permeable artificial leather by means of the adhesive 22.

At step 218, the piece of releasing paper is coated with a layer of polyurethane and baked in an oven. Then, the piece coated with the layer of polyurethane is adhered to the semi-product of the permeable artificial leather by means of an adhesive of polyurethane. After the adhesive of polyurethane is cured, the piece of releasing paper is removed and a milling process is conducted. Thus, the artificial leather is made with a realistic texture, grain effects and a low density, and permeable.

### EXAMPLE 2

At step 200, the non-woven cloth 10 is made of sea-and-island type fibers by means of needle punching. Each sea-and-island type fiber includes a sea portion of polyethylene and an island portion of nylon. The thickness of the non-woven cloth 10 is 1.4 mm. The density of the non-woven cloth 10 is 350 g/m².

At step 202, the solution contains 19% of the polymer resin, 1% of dye, and 80% of DMF solvent. The non-woven cloth 10 is immersed in the solution.

At step 204, the polymer resin is cured.

At step 206, the non-woven cloth 10 coated with the polymer resin is washed.

At step 208, the non-woven cloth 10 coated with the polymer resin is dried.

At step 210, the solvent is a solution of toluene. The non-woven cloth 10 coated with the polymer resin is immersed in the solvent in order to dissolve and remove the sea portion of polyester of each sea-and-island type fiber.

At step 212, the artificial leather is washed.

At step 214, the artificial leather is dried. Now, the fibers become 0.001 denier, and the semi-product 20 of the permeable artificial leather is made. The semi-product 20 of the permeable artificial leather is grinded in order to reduce the thickness thereof to 0.8 mm.

At step 216, the highly porous sheet 24 is made of polyurethane, and the porosity ratio is 80%, and the thickness 0.3 mm. The adhesive 22 is made of polyurethane. The highly porous sheet 24 is adhered to the semi-product 20 of the permeable artificial leather by means of the adhesive 22.

At step 218, the piece of releasing paper is coated with a layer of polyurethane and baked in an oven. Then, the piece coated with the layer of polyurethane is adhered to the semi-product of the permeable artificial leather by means of an adhesive of polyurethane. After the adhesive of polyurethane is cured, the piece of releasing paper is removed and a milling process is conducted. Thus, the artificial leather is made with a realistic texture, grain effects and a low density, and permeable.

### Second Embodiment

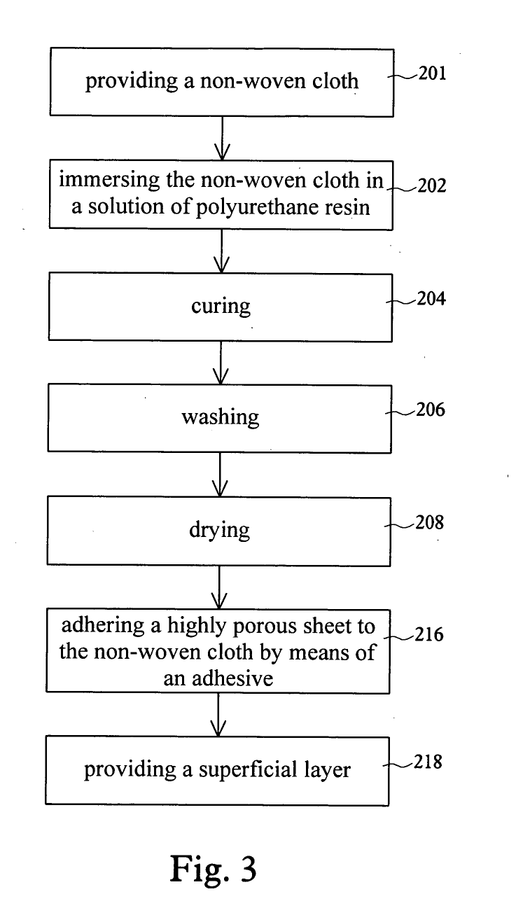

FIG. 3 shows a method for making the semi-product 20 of the permeable artificial leather according to a second embodiment of the present invention.

At step 201, the non-woven cloth 10 is made of nylon fibers and polyester fibers by means of needle punching or spunlace.

At step 202, the non-woven cloth 10 is immersed in a solution of a polymer resin.

At step 204, the polymer resin is cured.

At step 206, the non-woven cloth 10 coated with the polymer resin is washed.

At step 208, the non-woven cloth 10 coated with the polymer resin is dried. Thus, the semi-product 20 of the permeable artificial leather is made.

Then, the process goes to step 216 as shown in FIG. 2.

An example will be given in order to further discuss the method for making the permeable artificial leather according to the second embodiment of the present invention.

### EXAMPLE 3

At step 201, the non-woven cloth 10 is made of nylon fibers and polyester fibers by means of needle punching or spunlace. The non-woven cloth 10 includes 60% of nylon fibers and 40% of polyester fibers.

At step 202, the solution contains 12% of polyurethane resin, 1% of dye and 77% of DMF dissolvent. The non-woven cloth 10 is immersed in a solution of the polymer resin.

At step 204, the polymer resin is cured.

At step 206, the non-woven cloth 10 coated with the polymer resin is washed.

At step 208, the non-woven cloth 10 coated with the polymer resin is dried. Thus, the semi-product 20 of the permeable artificial leather is made, and the thickness thereof is 0.85 mm.

Then, the process goes to step 216 as shown in FIG. 2.

Tests have been conducted on the permeable artificial leather made according to the present invention compared with the artificial leather made according to U.S. Pat. No. 6,451,716. The comparison is shown in the following Table 1.

TABLE 1

| | | | | U.S. Pat. |
|---|---|---|---|---|
| | Example 1 | Example 2 | Example 3 | No. 6451716 |
| Permeability of liquid | 6.30 | 5.10 | 8.50 | 5.00 |
| mg/m² hr | | | | |
| Permeability of air | 1.82 | 1.40 | 2.20 | 0.50 |
| l/m² hr | | | | |
| Density g/m³ | 0.40 | 0.41 | 0.44 | 0.50 |
| Porous sheet density | 0.20 | 0.20 | 0.20 | none |
| g/m³ | | | | |

It can be learned from Table 1 that the artificial leather made according to the present invention exhibits a realistic texture, grain effects and a low density, and is highly permeable compared with the artificial leather made according to the U.S. Pat. No. 6,451,716.

The present invention has been described through the detailed description of the embodiments. Those skilled in the art can derive variations from the embodiments without departing from the scope of the present invention. The embodiments shall not limit the scope of the present invention defined in the claims.

What is claimed is:

1. A method for making artificial leather, the method comprising the steps of:
providing a non-woven cloth;
providing a semi-product of the artificial leather by means of immersing the non-woven cloth in a solution of a polymer resin;
providing a highly porous sheet made of resin; and
providing the final product of the artificial leather by means of adhering the highly porous sheet to the semi-product of the artificial leather so that gaps exist between the highly porous sheet and the semi-product of the artificial leather.

2. The method according to claim 1 comprising the step of providing a superficial layer on the highly porous sheet after the step of adhering the highly porous sheet to the semi-product of the artificial leather, the step of providing the super superficial layer on the highly porous sheet comprising the steps of:
providing a piece of releasing paper with a texture;
forming a layer of a resin on the piece of releasing paper;
removing the piece of releasing paper; and
providing the final product of the artificial leather with grain effects by means of conducting a milling process on the semi-product of the artificial leather.

3. The method according to claim 1 wherein the non-woven cloth is made of sea-and-island type fibers each comprising a sea portion and at least one island portion enclosed in the sea portion.

4. The method according to claim 3 comprising the step of dissolving and removing the sea portion of each of the sea-and-island fibers after the step of providing the semi-product of the artificial leather.

5. The method according to claim 3 wherein the remaining island portion of each of the sea-and-island fibers is 0.0001 to 0.8 deniers.

6. The method according to claim 1 wherein the step of providing the final product of the artificial leather comprises the step of providing an adhesive between the highly porous sheet and the semi-product of the artificial leather in a discontinuous manner.

7. The method according to claim 6 wherein the step of providing an adhesive between the highly porous sheet and the semi-product of the artificial leather in a discontinuous manner comprises the step of providing the adhesive in dots.

8. The method according to claim 6 wherein the step of providing an adhesive between the highly porous sheet and the semi-product of the artificial leather in a discontinuous manner comprises the step of providing the adhesive in a net-like pattern.

9. The method according to claim 1 wherein the highly porous sheet is made of polyurethane resin with porosity ratio of 60% to 90%.

10. The method according to claim 1 wherein the density of the highly porous sheet is 0.10 to 0.45 g/cm³.

11. The method according to claim 1 wherein the permeability of the artificial leather regarding liquid is higher than 5 mg/m² hr.

12. The method according to claim 1 wherein the permeability of the artificial leather regarding air is higher than 1.0 l/m² hr.

13. The method according to claim 1 wherein the non-woven cloth is made of ordinary fibers.

14. The method according to claim 13 wherein the ordinary fibers are made of at least one material selected from a group consisting of nylon and polyester.

15. Artificial leather comprising:
a non-woven cloth;
a highly porous sheet made of resin; and
an adhesive layer bonded between the highly porous sheet and the non-woven cloth.

16. The artificial leather according to claim 15 further comprising a superficial layer formed on the highly porous sheet and comprising a realistic texture that is open to the highly porous sheet.

17. The artificial leather according to claim 15 wherein the non-woven cloth is made of sea-and-island type fibers each comprising a sea portion and at least one island portion enclosed in the sea portion.

18. The artificial leather according to claim 17 wherein the island portion of each of the sea-and-island fibers is 0.0001 to 0.8 deniers.

19. The artificial leather according to claim 15 wherein the porosity ratio of the highly porous sheet is 60% to 90%.

20. The artificial leather according to claim 15 wherein the density of the highly porous sheet is 0.10 to 0.45 g/cm³.
